(19) United States
(12) Patent Application Publication
(10) Pub. No.: US 2010/0275266 A1
(43) Pub. Date: Oct. 28, 2010

(54) Automatically enhancing computing privacy by affecting the screen of a computing device

(76) Inventors: Gabriel Jakobson, Las Vegas, NV (US); Steven L. Rueben, Las Vegas, NV (US)

Correspondence Address: ATIDA LLC C/O STEVEN RUEBEN, 3862 RUSKIN STREET, LAS VEGAS, NV, 89147, US

(21) Appl. No.: 12/803,714

(22) Filed: Jul. 3, 2010

Related U.S. Application Data
(63) Continuation-in-part of application No. 11/496,382, filed on Jul. 31, 2006, now Pat. No. 7,779,475.

(51) Int. Cl. G06F 21/00

(52) U.S. Cl. 726/26

(57) ABSTRACT

A method of providing visual security enhancements to electronic data displayed on a display associated with an electronic device, comprising: defining privacy criteria; defining two physical states for operation of the display, wherein the first physical state includes displaying graphical output from the electronic device in a manner that is highly discernible to a viewer; and wherein the second physical state includes displaying the graphical output in a manner that is not highly discernable to the viewer;

receiving from an OS on the electronic device notification indicating a change to one or more applications running on the electronic device, the one or more applications containing visual data; in response to receiving the notification, examining the visual data contained in the one or more applications; determining if at least a portion of the visual data is included in the privacy criteria; in response to determining that at least a portion of the visual data is included in the privacy criteria, setting the display to the second physical state; and in response to determining that none of the visual data is included in the privacy criteria, setting the display to the first physical state.

The first physical state may be an approximation of an optimal display experience, with the brightness, contrast and color-balance of the display (i.e. screen) making the display easily discernable. The second physical state (herein “privacy state”) may include sub-optimal display settings, such as reduced brightness and/or less-than-optimal contrast and/or less-than-optimal color balance, etc. The privacy state may help private content to remain discernable for the user of the device yet substantially indiscernible to a person at a further distance and/or greater viewing angle from the screen of the device. The privacy state may be associated with email (e.g. displayed by a productivity application such as Microsoft Outlook®, or via any browser-based service such as GMail®, etc.) and other electronic communications such as all forms of instant messaging and social network communications.

### RELATED U.S. APPLICATION DATA

Continuation-in-Part of application Ser. No. 11/496,382, Filed 31 Jul. 2006

### FIELD OF INVENTION

The present invention relates to computer graphics applications. More particularly, the present invention relates to the application of graphics software to reduce the legibility of a computing device's screen to a potential viewer.

### BACKGROUND OF THE INVENTION

The evolution of computer screens has been progressively achieving higher resolution, brightness, sharpness, response time and contrast ratio. As screens are becoming larger, brighter and sharper, they are generally easier to read from a greater distance and wider angles. For example, laptops with passive-matrix screens, popular in the late 1990s, have been replaced with active-matrix, or TFT screens, in which each pixel is illuminated. The direct result is that a computer's TFT screen appears clearer and easier to read from a greater distance and wider viewing angle. New technologies continue to improve computer screens by increasing brightness and reducing glare, making screens easier to read in daylight and from greater distances and wider angles.

While the trend of bigger, better, brighter, and sharper screens offers a great benefit to the user, it also presents a drawback: the content of the screen may be more visible to prying eyes in the vicinity of the user. The proliferation of portable computers, e.g. the iPad® and similar hand-held computing devices, as well as laptops and smart phones with larger screen—and their usage at public places, compromise privacy. For example, more and more corporate users use their portable computers for work of potentially sensitive nature—ordinarily conducted behind closed doors in an office—at public places such as coffee shops and airplanes, where their screens could be read by dozens of people at any given time.

In recognition of the increased need for privacy demanded by computer users, hardware manufacturers have introduced hardware-based monitor security devices. Examples of hardware-based monitor security devices include computer privacy filters, or screens (collectively, privacy filters, unless otherwise noted), introduced by companies such as 3M®, feature a physical device that is adhered to, or placed over, a computer screen. Once such privacy filter is applied (i.e. placed over or adhered to) to a computer screen, its optics are designed to distort the view of the computer screen, when viewed from a wide angle or greater distance. The usage of a privacy filter may keep information displayed away from prying eyes, as a person to either side of the user may find their view of the computer screen distorted and intangible. Other related hardware-based monitor security devices are computer LCD screens that are manufactured in such way that they can be “read” (or viewed in a tangible way) only by a user sitting directly in front of them. Alternatively, users can reduce the brightness of their computing devices, usually via a physical control or a keyboard-key combination. While reducing the brightness of a screen does make the screen less discernable to more distant viewers, the manual steps required to make the screen brighter-dimmer-brighter make this option not very viable.

Hardware-based monitor security devices have multiple drawbacks. Among these drawbacks is the bulk and inconvenience, especially for mobile computing. Some filters are not easily removed from a monitor to allow viewing without the distorting effect of the screen, which users may want to do when security is less of a concern (as when a computer user may be using the computer to show something to others). Additionally, hardware monitor security devices in the form of privacy screens are ineffective in giving the audience of a presentation on a large display, such as an LCD projector or large flat screen TV, privacy from prying audience who may be standing a substantial distance away. (e.g. a LCD projected presentation at a company board room with glass walls, where people standing outside the room may be able to see sensitive projected information). There are other limitations and drawbacks of hardware monitor security devices than those described above.

### DESCRIPTION OF THE DRAWINGS

For a more complete understanding of the present invention and further advantages thereof, references are now made to the following Detailed Description, taken

FIGS. 1A and 1B are generalized block diagrams illustrating a key difference between one preferred embodiment of the present invention and the prior art.

FIG. 2 is a generalized block diagram illustrating interaction of various components in a computing environment 200 in one possible embodiment of the present invention.

FIG. 3 is a generalized flow diagram illustrating exemplary interaction between an OS running on an electronic device and a privacy application on the electronic device, according to one possible embodiment of the present invention.

FIGS. 4A, 4B and 4C are generalized block diagrams illustrating a user's interface into defining criteria for a privacy application, in one possible embodiment of the present invention.

FIGS. 5A & 5B are generalized flow diagrams illustrating associating file types with a privacy setting, and invoking the privacy setting automatically in response to detecting the running of applications of the associated file type, according to one embodiment of the present invention.

FIGS. 6A & 6B are generalized flow diagrams illustrating associating email settings with a privacy setting, and invoking the privacy setting (i.e. altering physical properties of the display) automatically in response to receiving an email, according to various possible embodiments of the present invention.

FIGS. 7A and 7B are generalized block diagrams illustrating visual effect that may be created by a computer system operating according to one embodiment of the present invention.

### SUMMARY OF THE INVENTION

A software-implemented method for allowing a user to enhance privacy of their computing device's display, is disclosed. The user may define parameters (e.g. various application types such as documents, emails containing specific words in their subject lines or sent by specific senders, etc.) to automatically trigger a privacy mode. The privacy mode may comprise changing attributes of the physical display. For example, the physical display may automatically reduce its brightness level in response to the invocation of the privacy mode. In alternate embodiments, the physical display may change its contrasts, color balance, or any other display-related attributes. In response to the automatic de-invocation of the privacy mode (e.g. the user closes or minimizes a document that had triggered the privacy mode), the physical display may restore to its previous, optimal settings.

### DETAILED DESCRIPTION

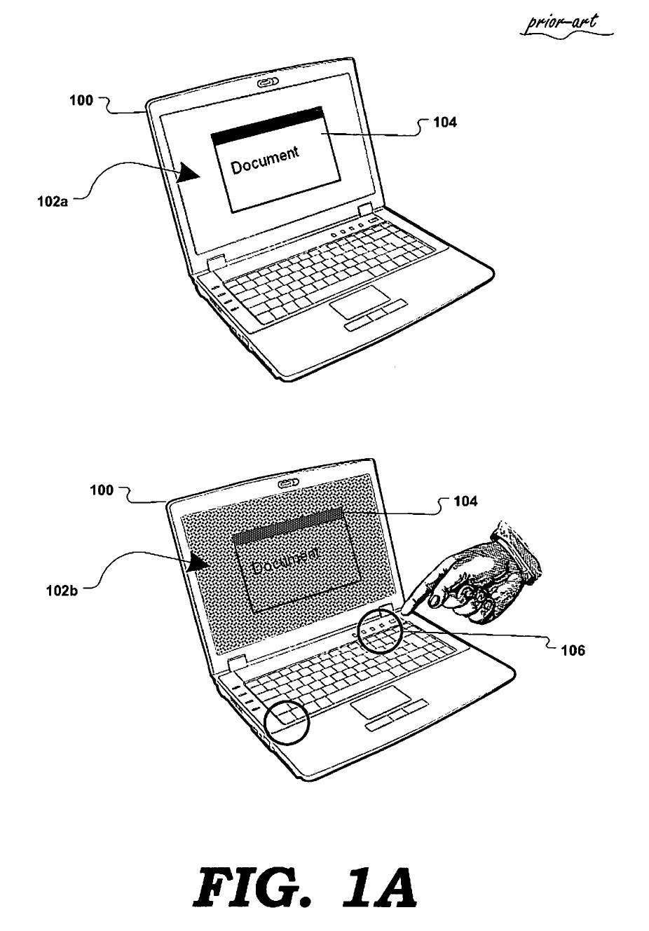

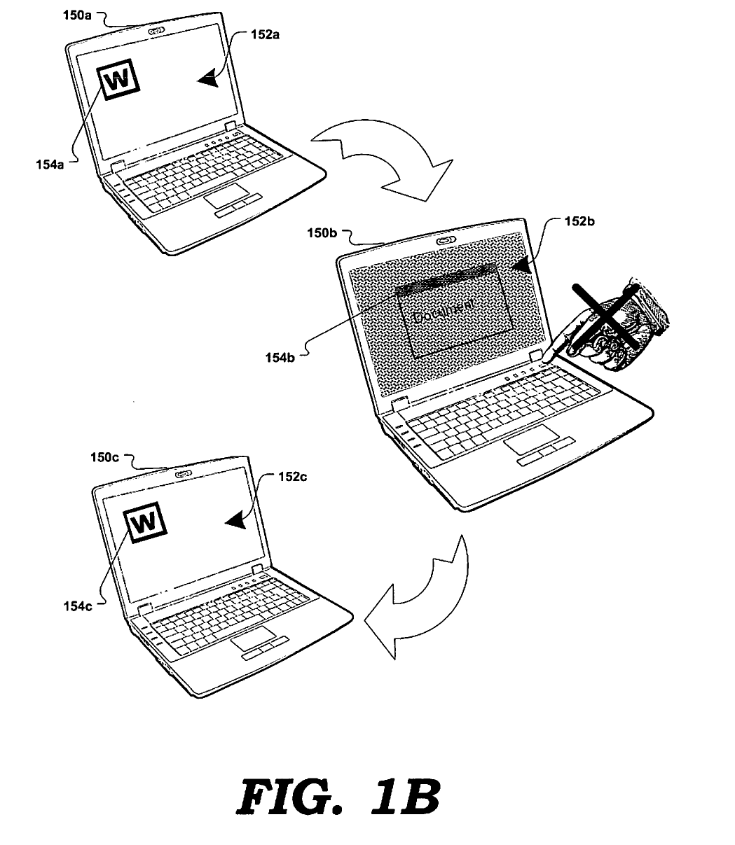

FIGS. 1A and 1B are generalized block diagrams illustrating a key difference between one preferred embodiment of the present invention and the prior art. Dimming a computing device's display, in the prior art, can be accomplished manually (e.g. via a keyboard key combination press; or a physical hardware switch; or via a “virtual switch” such as a computer application allowing a user to use a pointing device to slide a control and alter screen brightness); or automatically in response to external sensors (e.g. a photo-voltaic sensor with the help of which the screen brightens may be automatically varied in response to environmental lighting conditions.) In the present invention, display brightness may be automatically varied by a software application in response to execution of application on the electronic device.

Referring to FIG. 1A, in the prior art, an electronic device 100 (e.g. a laptop, an iPad®, etc.) may display content 104 on a physical display (e.g. LCD screen) 102a. The user may alter the brightness of the display (illustration designated 102b, representing a dimmed stated of the physical display when it is designated 102a) using various hardware means: buttons and controls 106 built into, or connected to, the computing device 100. Generally, the dimmer (i.e. less bright) the physical display 102b, the harder it is for a second user, at a greater distance and/or angle to the physical display 102b, to discern the content 104 displayed on the physical display 102b.

In a use case related to the present invention, when displaying the content 104 (e.g. a sensitive document), the user may use manual means 106 (e.g. keyboard keys, switches, software application controls) to reduce the brightness (i.e. dim) the physical display 102b. When done displaying the content 104, the user may use similar manual means to restore the physical display to its previous bright state.

Referring now to FIG. 1B, according to one preferred embodiment of the present invention, dimming and un-dimming of a physical display may be carried out automatically. A computing device 150a, connected to a physical display 152a, operating at a normal brightness level, may display an icon (or minimized application) 154a. In response to a user's launching/maximizing the application 154b, the physical display 152b may automatically (i.e. with no proactive user intervention) decrease in brightness—allowing the user to view the application 154b in relative privacy, as it is harder for other viewers to discern data displayed on the physical display 154b under dimmer lighting.

The user's minimizing/closing of the application 154c may cause the brightness level of the physical display 152c to be automatically restored to the previous level, illustrated as 152a.

One of the distinct advantages of the present invention, illustrated in FIG. 1B, over the prior art, illustrated in FIG. 1A, is that the brightness of the physical display changes automatically, in response to the state of one or more applications being displayed, with no other user action required to alter the state of the display (I.e. its brightness level). In alternate embodiments, other properties of the physical display may change, such as contrast, color balance, color saturation, hue, etc.

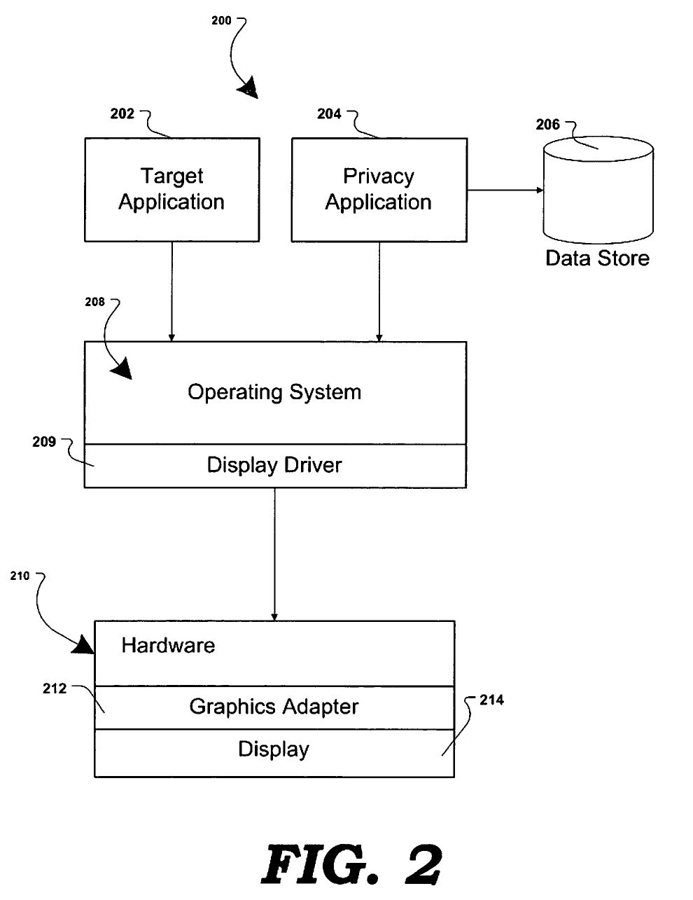

FIG. 2 is a generalized block diagram illustrating interaction of various components in a computing environment 200 in one possible embodiment of the present invention. The present invention may function on any computing device connected to any physical display capable of altering its brightness.

A privacy application 204, operating in accordance with the teachings of the present invention, may operate on top of an operating system (“OS”) 208. The privacy application 208 may establish a two-way communication with the OS 208, receiving information on other applications and processes running on top of the OS 208.

A user may define target applications and processes 202 in response to which to trigger and affect screen brightness. Settings, such as user preferences of application names, types and any other application-related properties used for triggering; as well as other preferences such as brightness level, application behavior in response to which the screen brightness changes, etc, may be stored in a data store 206 (e.g. registry, data base, hard drive, etc.) associated with the computing device.

In response to invocation of the target application 202, the OS 208 may communicate to the privacy application (e.g. via messages or events) the state of the target application 202 (e.g. loaded, maximized, in-focus, etc.) The privacy application 204 may determine a desired privacy setting for the state of the target application 202.

If it determined that a privacy state is to be invoked, the privacy application 204 may communicate to the OS 208 an instruction to affect the physical display 214 associated with the computing device. The OS 208 may communicate with a hardware layer 210 (directly or via BIOS, a graphics display drivers 209, or other mechanisms) instructing the hardware 210 to cause the screen 214 to alter its brightness level. The hardware layer 210 may comprise a graphics adapter 212 physically driving the display 214.

In response to changes in the state of the target application 202, the privacy application 204 may affect the brightness of the screen 214, via the OS 208 and hardware layer 210. In alternate embodiments, the privacy application 204 may be part of the OS 208, the hardware layer 210, or part of any other component generally associated with the computing system 200, without deviating from the scope of the present invention.

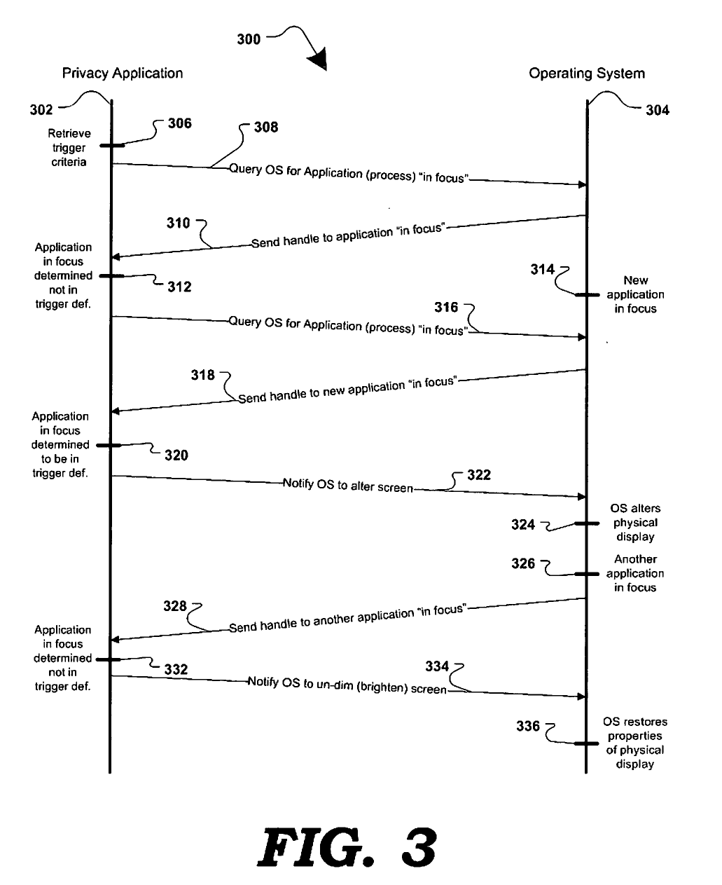

FIG. 3 is a generalized flow diagram illustrating exemplary interaction between an OS running on an electronic device and a privacy application on the electronic device, according to one possible embodiment of the present invention. Please note that in some cases, the order of specific steps in the flow may be interchangeable without affecting the overall scope or functioning of the invention.

A system 300 may comprise a privacy application 302 (e.g. an executable application with graphical user interface and access to storage) and an OS 304, both running on—or in association with—the electronic device illustrated by the system 300. In one preferred embodiment, the privacy application 302 may be running on top of the OS 304 and communicate with the OS 304 via application programming interface (“API”).

At step 306, the privacy application may retrieve trigger criteria. For example, the user may define criteria as triggers, such as various types of applications, documents, content, media, email, etc., based on which the privacy application is to be triggered. The criteria may be stored and retrieved by the privacy application at step 306.

At step 308 the privacy application may query the OS 304 for a handle to the application in focus (i.e. the application—e.g. one displaying email or a document—that sits on top of other applications and thus is most visible to the user). A handle to the application in focus, provided by the OS 304 at step 310, may allow the privacy application to query the application in focus for details, such as the type of document the application in focus is displaying, etc.

At step 312 it may be determined whether the application in focus meets the trigger criteria retrieved at step 306. For example, if the trigger criteria specifies “any application displaying a .PDF (i.e. Adobe® Acrobat®) document whose title contains the word ‘salary’” is to be triggered upon, any application meeting this criteria will trigger a positive result. In this example, at step 312 the application in focus is determined not to meet the triggering criteria; therefore, at step 316 a request for the OS 308 similar to the request at step 308 may be made, querying the OS 308 for a new handle of a new application in focus.

At step 314, in this example, a new application comes into focus (e.g. the user launches a new application, loads a new document, maximizes an application, navigates to a new website, etc.) At step 318 the OS 308 may send a handle to the new application in focus to the privacy application 304. At step 320 it may be determined that the new application in focus does meet the triggering criteria. In response, at step 322, the privacy application 304 may send a message to the OS 308 to alter (e.g. dim) the physical display.

In response, at step 324 the OS 308 may alter (dim, change contrast, colors, etc.) the physical display. In other closely related embodiments, the OS and/or the privacy application may first capture and store the current state of the physical display, so that in future the current (i.e. previous) state of the display may be easily retrieved and reverted to; and/or further logic and rules may be applied to the type of alteration to the display, e.g. level of brightness, contrast, etc.

In this example, at step 326, the OS may detect another application coming into focus (e.g. the user may have closed the previous “triggerable” application or opened the other application on top of the previous one.) At step 328 the OS 308 may transmit to the privacy application 304 a handle to the last application in focus at step 326. In this example, at step 332 it may be determined that the last application does not meet triggering criteria, in response to which, the privacy application 304 may notify the OS 308 via a message 334 to restore the physical display to its previous state. The OS may restore the physical display to its previous (i.e. pre-altering/dimming) state at step 336.

In alternate possible embodiments, the privacy application depicted herein may not be an application per se, but rather a module (code-component/algorithm/plug-in/routine, etc.) of the OS and/or a graphics driver used by the OS and/or any other software or hardware used in conjunction with a computing device that is part of a system illustrated herein.

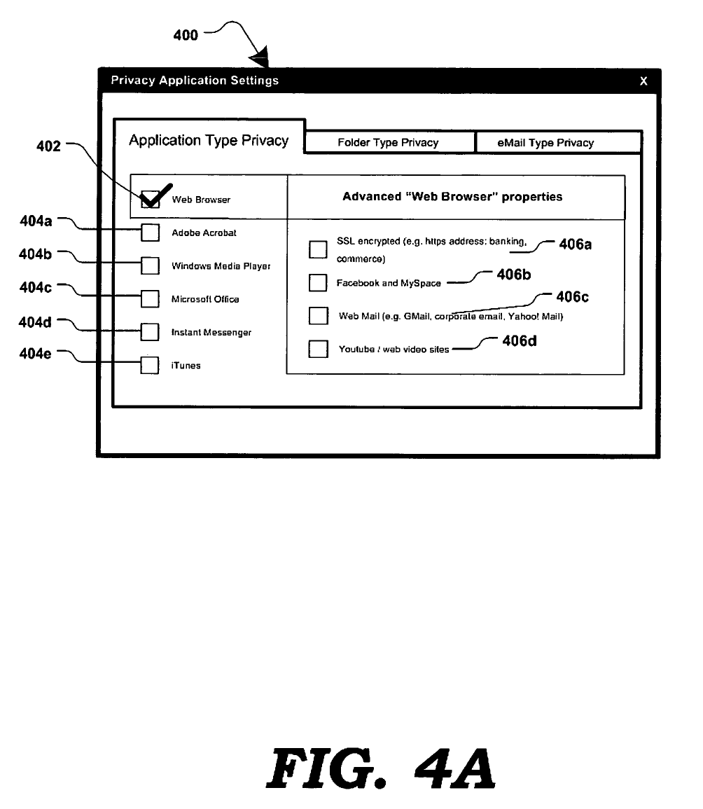

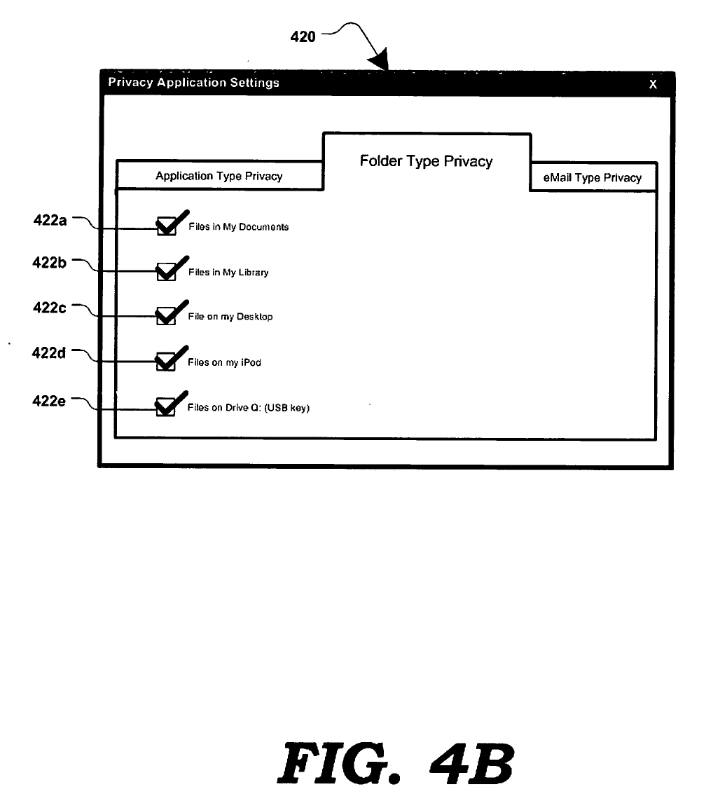

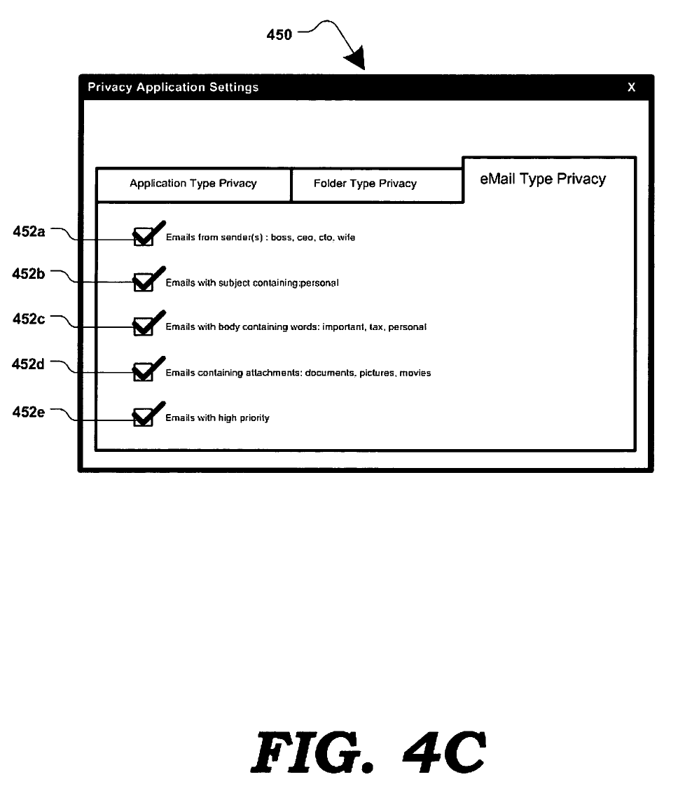

FIGS. 4A, 4B and 4C are generalized block diagrams illustrating a user's interface into defining criteria for a privacy application, in one possible embodiment of the present invention. Criteria could be as simple as a general type of an application, like a Microsoft® Word® application; or, as complex as “a web page containing the word ‘account’ and URL containing ‘Bank of America’”. Thus it is beneficial to allow the user to select precise criteria for triggering privacy.

Referring to FIG. 4A, an exemplary application window named “Privacy Application Settings” 400 is illustrated. Various application types may be selectable by the user: a web browser 402, Adobe® Acrobat® 404a, Windows® Media Player 404b, Microsoft® Office® 404c, Instant Messenger 404d, iTunes® 404e, etc.

For example, the user's checking Instant Messenger 404d may mean that every time the user receives or send an instant messenger (“IM”) message, the screen of their electronic device may dim, enhancing the user's privacy. In this example, the user may use their laptop with the screen at a high brightness level. Their IM application may come into focus as they receive an IM from a friend. The screen of their laptop may dim automatically, enhancing their privacy. When they minimize the IM window, the brightness of their screen may automatically be restored to its pervious bright state.

Application types may be further be configurable to trigger on more specific properties and attributes, such as the contents of an application. For example, it may not be desirable to trigger generally on an application of type “Web Browser” 402—the user may use a web browser for entirely non-personal reasons, such as checking traffic or the weather. However, in one possible embodiment, the user may be able to define specific attributes of the web browser upon which to trigger privacy settings.

For example, the user may elect only web browsers displaying a website that is SSL encrypted 406a (with https in the URL line, e.g. banking websites) to trigger privacy settings. The user may choose social networking websites 406b such as Facebook® and MySpace® to trigger privacy settings. The user may choose web-mail applications 406c (e.g. Gmail, Yahoo! Mail, hotmail, corporate email, etc.) to trigger privacy. The user may choose media websites 406d (e.g. youtube) to trigger privacy settings. In all these embodiments the privacy application may establish a hook into the web browser and query the content displayed by the web-browser, scanning for specific content. For example, the privacy application may invoke specific API calls to query the URL displayed by a specific web-browser whose handle the privacy application has a handle to. In an alternate embodiment, web-browser plug-ins/ActiveX controls/add-ons may perform a related function.

Referring now to FIG. 4B, in another possible embodiment, files contained in various select folders/locations may be associated with privacy settings: an opening of a file contained in one of the select folders may cause the display to switch to a privacy mode, i.e. dim the brightness of the display.

The user may select various folders and locations. Some possible examples are: files located in My Documents 422a (in Microsoft Windows®, or equivalent folders in other OSs); files in My Library 422b; files on the user's desktop 422c; files on a user's iPod® 422d (or any other electronic device attached to the user's computer); files located on flash drives/USB sticks 422e, etc.

For example, the user may choose to save only personal documents in the My Documents folder on their computer. Opening any file saved into My Documents, such as a Microsoft Word® document, may cause the display to dim automatically. By contrast, in this example, opening the same document if it is copied to a different folder, may not cause the display to dim automatically. In another example, the user may carry a USB stick containing personal document, such as pictures. When the user plugs the USB stick into their laptop and selects any files on the USB sticks to open, the screen may dim automatically (until the user closes or minimizes the file, in which case the screen may restore its previous “bright state” automatically.)

Referring now to FIG. 4C, privacy settings may be associated with emails. In one embodiment, privacy settings may be associated with a desktop email client application, such as Microsoft Outlook®. In an alternate embodiment, email privacy settings may be associated with a “cloud-based email”, such as GMail®. FIG. 4C illustrated a general example of the user's selecting criteria for triggering the dimming of their screen in response to various emails containing select attributes.

For example, the user may define criteria related to an email's “sender” field 452a. A user's opening a new email (or brining a window displaying the email to the forefront such that it is visible over other applications) may trigger the privacy settings if the email's “sender” field contains key words/names/emails selected by the user. For example, an email whose sender is “boss” or “John Doe” or “wife” or “ceo@mycompany.com” may cause the brightness of the screen to dim.

As another example, the user may define criteria related to an email's “subject” line 452b. A user's opening a new email (or brining a window displaying the email to the forefront such that it is visible over other applications) may trigger the privacy settings if the email's subject line contains pre-selected key words such as “personal”, “salary”, “HR”, “taxes”, etc.

As another example, the user may define criteria related to an email's “body” 452c. A user's opening a new email (or brining a window displaying the email to the forefront such that it is visible over other applications) may trigger the privacy settings if the email's body contains pre-selected key words such as “personal”, “salary”, “HR”, “taxes”, etc.

As another example, the user may define criteria related to an email's attachments 452d. A user's opening a new email (or brining a window displaying the email to the forefront such that it is visible over other applications) may trigger the privacy settings if the email includes attachments of various types such as pictures, movies, documents, etc. [0xx] Various other email attributes may be triggerable, such as emails marked with high priority 452e, emails with other recipients CCed, or any combination of the aforementioned attributes and other possible attributes.

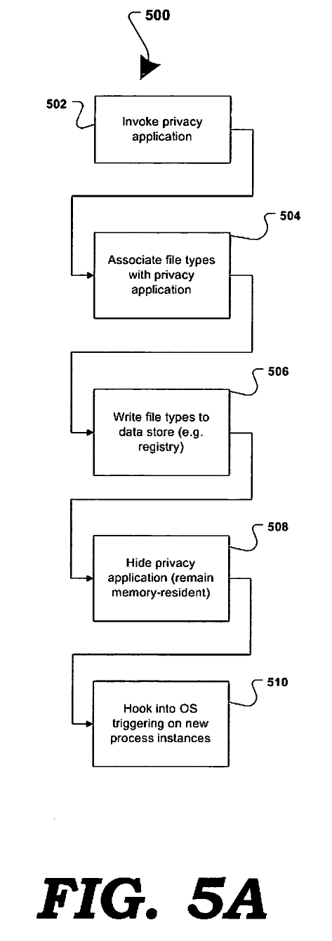

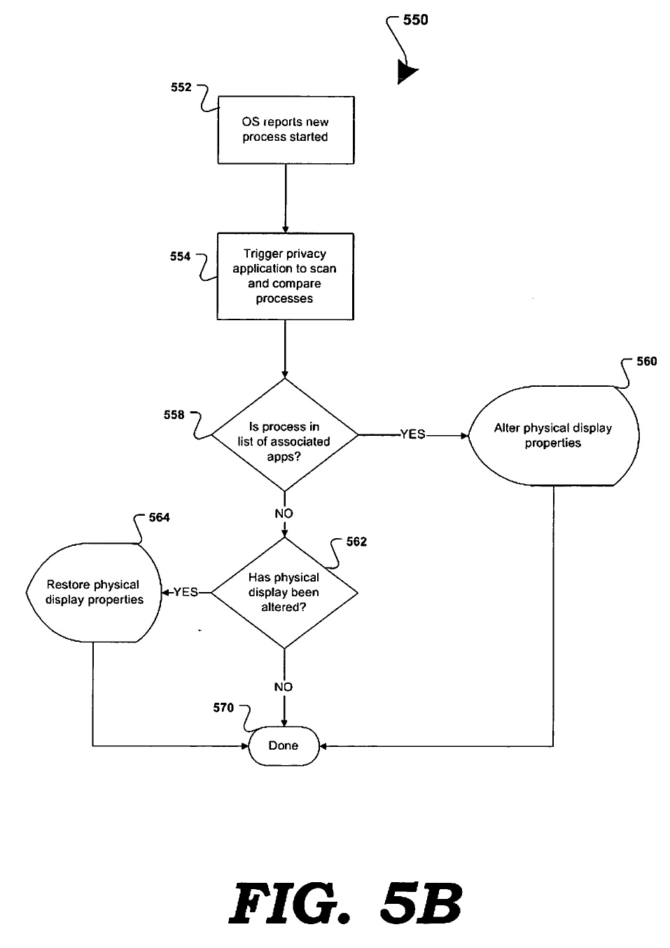

FIGS. 5A & 5B are generalized flow diagrams illustrating associating file types with a privacy setting, and invoking the privacy setting automatically in response to detecting the running of applications of the associated file type, according to one embodiment of the present invention. The privacy setting may dim or otherwise alter physical properties of a physical display associated with an electronic device. An application, capable of invoking the privacy setting, may be invoked on the operating system (“OS”) of a client device (e.g. a PC or laptop running a Microsoft®-based OS or Linux® or a Mac® OS; an iPad® or any other smart phone/hand held device, etc.) The application may be configured by a user to asset the privacy setting in response to discovering an instance of another specific type of application running by the OS. The privacy setting may then alter the physical display accordingly.

Referring to FIG. 5A, flow chart 500 illustrates one embodiment of the present invention in which a privacy setting may be associated with an application type, and automatically invoked in response to detecting execution of the application of that type. At step 502, a privacy application (e.g. the application which creates the privacy setting) may be invoked. At step 504, a user may associate file-types with privacy settings. For example, the user may associate the file-type “.doc” or “.pdf” with privacy settings, resulting in every Microsoft Word® or Adobe Acrobat® document displayed by the user, automatically triggering dimming of the physical display/computer screen.

At step 506, user selections may be written to a data store (e.g. Windows®' registry, a cookie used by a web browser, a database connected to an interne service accessed via a web browser, etc.) The user selections recorded at this step may be used later to automatically invoke the privacy setting upon detection of an application associated with the user selection.

At step 508 the privacy application may be hidden from view (i.e. become “memory resident”) but maintain its OS-running status. For example, the privacy application may be a Windows® service, invoking privacy setting thus dimming the display.

At step 510 the privacy application may hook into the OS running on the electronic device; i.e. the privacy application may register a request with the OS to receive an event when the OS launches a new process.

Referring now to FIG. 5B, flow diagram 550 illustrates receiving an event from the OS indicating the starting of a new process; and, in response to determining the new process is within the selected list of processes, invoking the privacy setting, thus altering the physical display.

At step 552 the OS may send an event to the privacy application notifying the privacy application that a new process has been started (indicating a new application) has been launched. In response, at step 554 the memory-resident privacy application may be invoked to compare the new process with the list of selected applications over which to invoke the privacy setting.

If at step 556 it is determined that the new process from step 552 is on the list of selected applications, at step 560 the privacy setting may be invoked, for example by changing the brightness and/or contrast and/or color balance of the physical display.

If at step 558 it is determined that the process is not in the list of associated applications, at step 562 it may be determined whether the privacy mode had already been invoked (i.e. is the screen currently in an altered state.) A negative result from the determination at step 562 may end the flow at step 570. A positive result from the determination at step 562 may restore the display to its pre-altered state (i.e. optimal brightness and/contrast and/or color balance) and the flow may end at step 570.

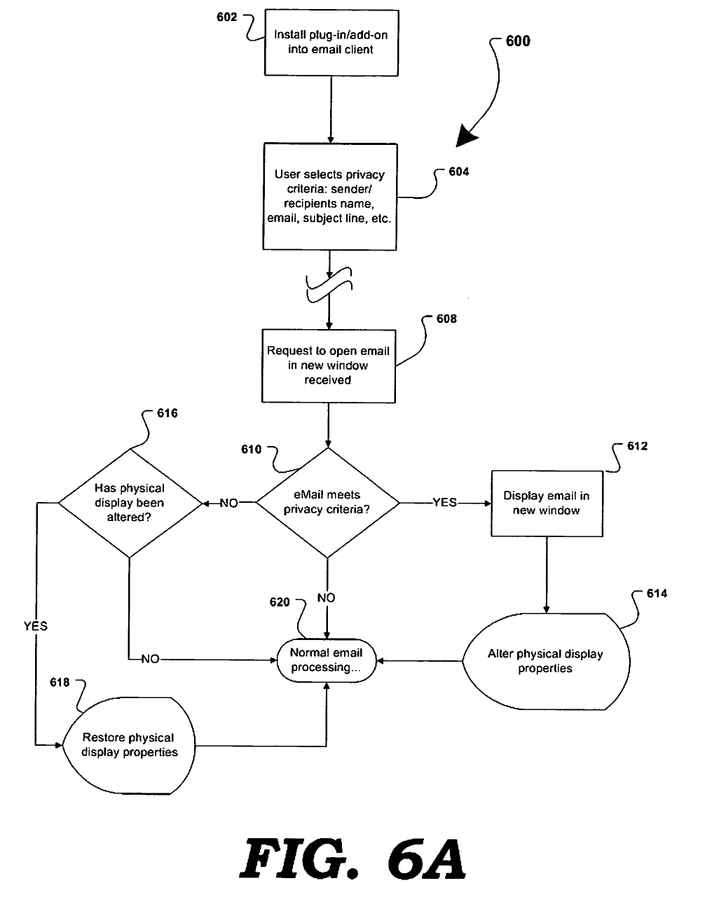

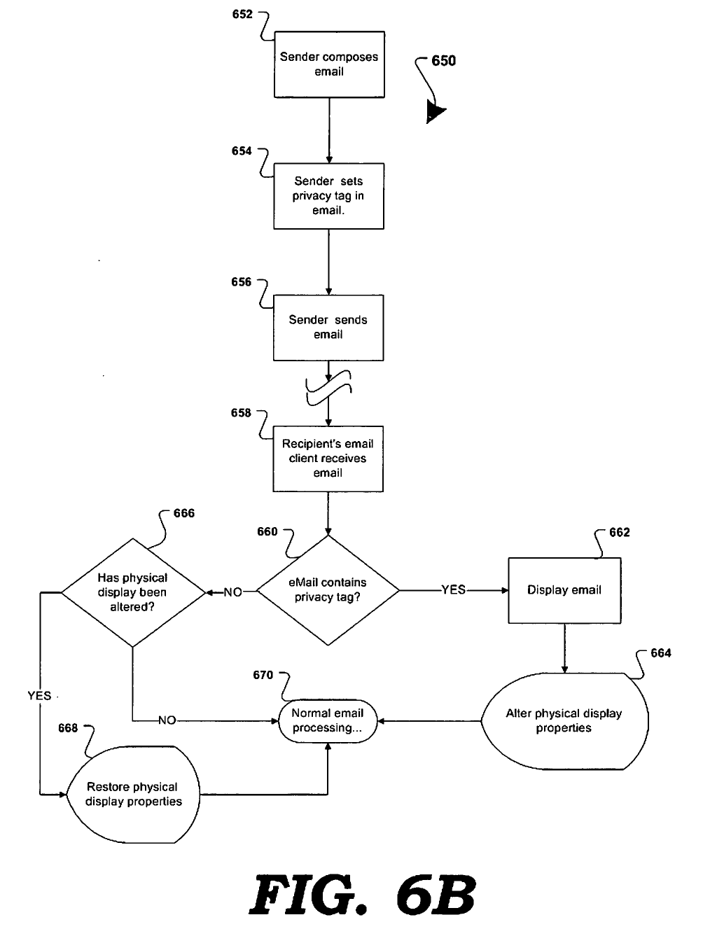

FIGS. 6A & 6B are generalized flow diagrams illustrating associating email settings with a privacy setting, and invoking the privacy setting (i.e. altering physical properties of the display) automatically in response to receiving an email, according to various possible embodiments of the present invention. The term “email” may refer to an email client application (e.g. Microsoft Outlook®, email client applications on handheld devices such as iPhone® and iPad®) as well as web-based email applications through a web browser such as GMail®, Hotmail®, etc.) In the former case, a privacy setting may be invoked in response to the email client. In the latter case, the privacy setting may be invoked in response to a web-browser applications associated with email.

Referring to FIG. 6A, flow diagram 600 illustrates an algorithm in which a privacy setting is associated with email based on specific email attributes (e.g. sender, subject line, key-words included in email, etc.) The algorithm illustrated herein may be used both by application-based email clients and web-based email, with minor technical modifications based on OS, device type, web-browser type, etc.

At step 602 a plug-in or add-on may be added to an email client application (e.g. in a case of a web-based client, a plug-in may be added, whereas in a case of an application-based email client, an add-on type module may be installed on the same OS.)

At step 604, the user may define criteria (“email security-window criteria”) based upon which a privacy setting may be invoked in association with a specific email. Drawing an analogy to criteria used to filter spam or automatically route emails, the email security-window criteria may be based on one or more of the following attributes: sender's name, sender's email address, key words included in the email's subject-line and/or email body, etc. For example, the user may set a rule whereby all emails coming in from email address “ceo@mycompany.com” are displayed with a security filter automatically overlaying the window/browser in which the emails are displayed. Similarly, a more complex rule may be set up whereby a series of conditions need to be met for a privacy setting to be invoked (e.g. email sender's address must include a certain domain name and subject like must include a certain key word.)

Past step 604, the email application may resume normal functionality, until a new email-opening event is received. In response to a user's opening an email at step 608, at step 610 it may be determined whether an individual email, requested to be opened at step 608, meets the email privacy setting criteria defined at step 604. For example, if at step 604 the criteria had been defined to include emails whose sender address is ceo@mycompany.com, at step 610 it may be determined that the individual email meets the email privacy setting criteria.

Following a positive determination at step 610, at steps 612-614 the privacy setting may be invoked, substantially reducing a non-primary's user ability to discern the screen and read the email. At step 612 the individual email may open in a new email window (alternatively, the individual email may be displayed within an existing email application window, in which case the existing email application window may be substituted for the new email window in this illustration.) At step 614, in response to the invocation of the privacy setting, the physical display may be dimmer or otherwise altered. At step 620 normal email operation may resume.

If at step 610 it is determined that the email is not in the list of triggerabe critera, at step 616 it may be determined whether the privacy mode had already been invoked (i.e. is the screen currently in an altered state.) A negative result from the determination at step 616 may end the flow at step 620. A positive result from the determination at step 616 may restore the display to its pre-altered state at step 618 (i.e. optimal brightness and/contrast and/or color balance) and the flow may end at step 620.

Alternatively, or in addition to, the methodology illustrated in FIG. 6A, referring now to FIG. 6B, flow diagram 650 illustrates an embodiment wherein a sender of an email may request that a privacy setting be invoked when their email is opened by a recipient. For example, a CEO of a company sending a CFO a sensitive email may set a privacy tag (or attribute) in the email, causing the email to open up obstructed by a privacy setting.

At step 652, an email may be composed be a sender. At step 654, the sender may set an attribute (“security tag”) in the email indicating a request to invoke the privacy setting in response to the email when received and opened by a recipient. In one possible embodiment, the sender may use the email client to set the security tag using a menu selection or any graphical mean (e.g. similarly to a common way in the prior art for setting the “importance” attribute of an email—typically by selecting a designated graphical control in the email client, such as a button labeled with an exclamation mark—causing the email to be received by the recipient and be displayed marked as “important”.)

At step 656 the sender may send the email using any known, common method, and at step 658 the recipient's email client may receive the email. At step 660, the recipient's email client (e.g. a desktop-based productivity application, a web-based email application accessible via a web-browser, etc.) may determine whether the email contains the security tag. If it is determined at step 660 that the email contains the security tag, at steps 662 the privacy setting may be invoked, resulting in altering the physical display. The alteration of the physical display, e.g. in the form of dimming the display and/or modifying the display's contrast and/or modifying the display's color balance, is designed to make it harder for users other than the primary user to discern the email. At step 670, the flow may end and normal email operation may resume.

If at step 660 it is determined that the email is not in the list of triggerabe criteria, at step 666 it may be determined whether the privacy mode had already been invoked (i.e. is the screen currently in an altered state.) A negative result from the determination at step 666 may end the flow at step 670. A positive result from the determination at step 666 may restore the display to its pre-altered state at step 668 (i.e. optimal brightness and/contrast and/or color balance) and the flow may end at step 670.

In a similar manner, other forms of electronic communication—such as instant messages (“IM”) and messages from social networks (e.g. friends on Facebook® or Twitter® sending messages) may trigger automatic dimming of the physical display.

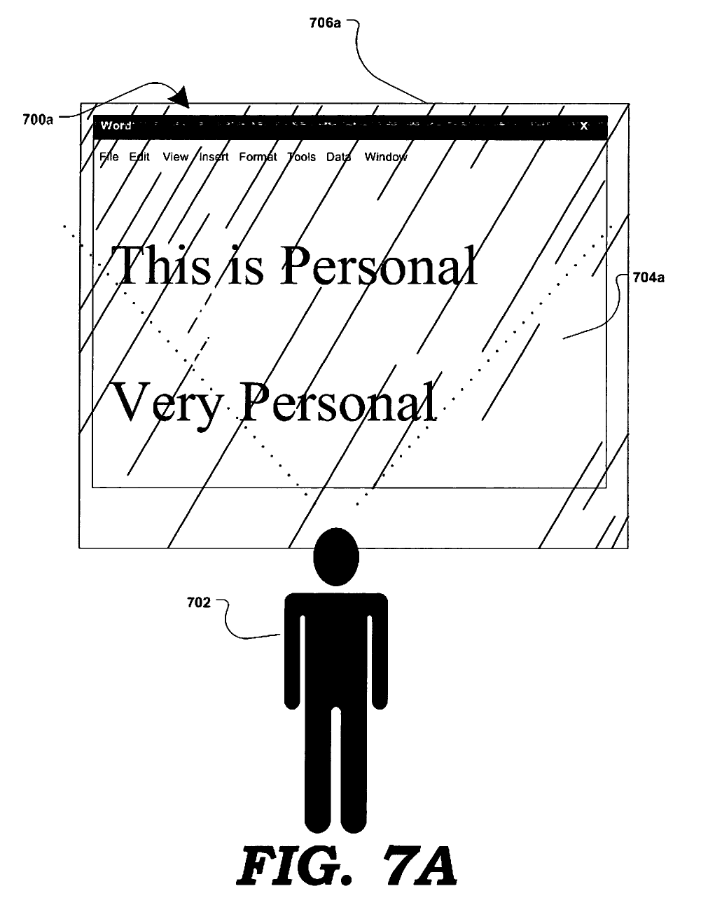

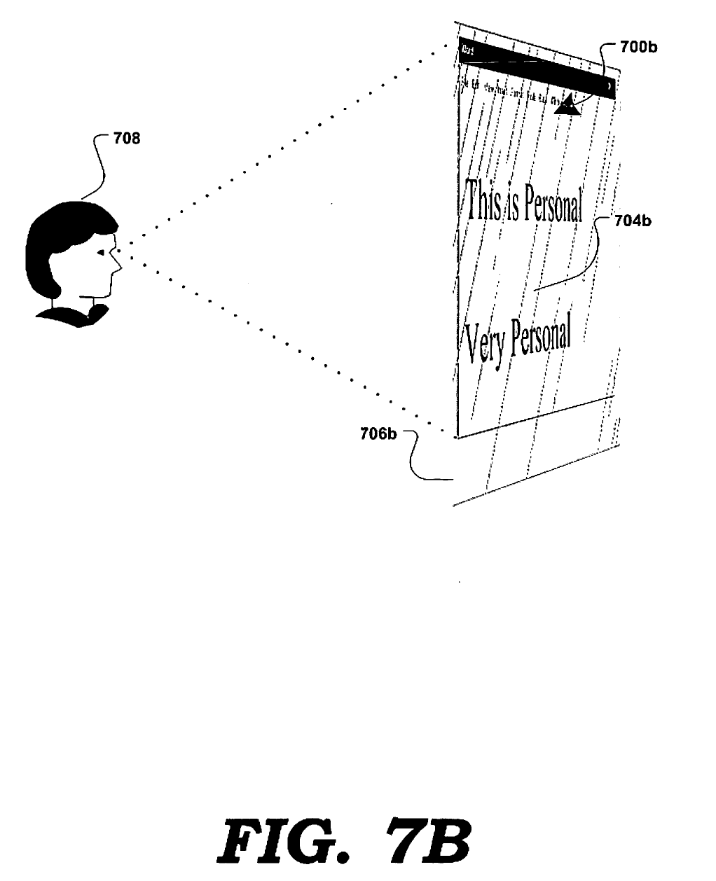

FIGS. 7A and 7B are generalized block diagrams illustrating visual effect that may be created by a computer system operating according to one embodiment of the present invention. Application 700a may be viewed by a user 702 sitting at a normal viewing position of a device's display (i.e. substantially in front of the display, leveled with it and in relatively close proximity.) As shown, FIG. 7A illustrates a view essentially from behind the user 702. FIG. 7B illustrates a perspective view from one side of a user. Application 700a may be partially obstracted by the low-brightness level of the device's display (illustrated herein by a cross-hatched rectangle representing a dimmed display.) by

The application 700a may contain content 704a which in this case contains the text “This is Personal Very Personal”. Despite the dimness of the display, the user 702 is still able to read and discern the phrase “This is Personal Very Personal”, primarily due to their proximity to the display.

Referring now to FIG. 7B, A second person 708 may look at the same display device, displaying the same application 700b, from a greater distance and broader angle. Due to the dimness of the screen 706b, the second person 708 may not be able to discern the content “This is Personal Very Personal” 704b. Thus with the advent of this invention, while the primary user 702 may be able to discern the contents of the document 700a with relatively little strain, user that are farther away and/or at a great viewing angle, may find it exponentially more difficult to discern the display overcoming the display's dimness 706b.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. A method of automatically enhancing security of information displayed by an electronic device, the electronic device capable of outputting a signal to a display for displaying information to a user of the electronic device, comprising:
defining criteria for enhanced privacy;
detecting the displayed information;
determining the displayed information meets criteria for enhanced privacy;
altering properties of the display;
detecting a new state of the displayed information;
determining the new state of the displayed information does not meet the criteria for enhanced privacy; and
reverting the properties of the display to their state prior to the altering the properties of the display;
wherein the altering and the reverting of the properties of the display are executed automatically in response to the two determining steps.

2. The method of claim 1, wherein the altering and revering the properties of the display comprises affecting brightness of the display.

3. The method of claim 1, wherein the reverting the properties of the display includes increasing the brightness of the display.

4. The method of claim 3, further comprising the steps of:
prior to the altering the properties of the display, recording the properties of the display;
prior to the reverting the properties of the display, retrieving the recorded properties; and
reverting the properties of the display to the recorded properties.

5. The method of claim 2, further comprising:
allowing the user to define a first desired brightness level and a second desired brightness level;
wherein the first desired brightness level is to be used when the displayed information is determined to not meet the privacy criteria; and
wherein the second brightness level is to be used when the displayed information is determined to meet the privacy criteria.

6. The method of claim 5, wherein in response to determining the displayed information meets the criteria for enhanced privacy, altering the display brightness to match the first desired brightness level.

7. The method of claim 5, wherein in response to determining the displayed information does not meets the criteria for enhanced privacy, altering the display brightness to match the second desired brightness level.

8. The method of claim 1, further comprising:
receiving user input;
constructing the criteria for enhanced privacy from the received user input; and storing the criteria for enhanced privacy.

9. The method of claim 1, wherein the step of detecting the displayed information further comprises:
receiving from an operating system (“OS”) on the electronic device a handle to an application visible to the user; and
utilizing application programming interface (“API”) to determine the displayed information within the application.

10. The method of claim 9 wherein the application is a web-browser.

11. The method of claim 10, wherein the web-browser displays content off the internet, the internet content comprising the displayed information.

12. The method of claim 9, wherein the step of receiving the handle from the OS further comprises receiving the handle to the application both visible to the user and determined to be in-focus by the OS.

13. The method of claim 12, wherein the step of receiving the handle from the OS further comprises:
receiving from the OS a plurality of handles to all running applications; and
determining from the plurality of handles the handle to the application determined to be in-focus.

14. A method of providing visual security enhancements to electronic data displayed on a display associated with an electronic device, comprising:
defining privacy criteria;
defining two physical states for operation of the display, wherein the first physical state includes displaying graphical output from the electronic device in a manner that is highly discernible to a viewer; and
wherein the second physical state includes displaying the graphical output in a manner that is not highly discernable to the viewer;
receiving from an OS on the electronic device notification indicating a change to one or more applications running on the electronic device, the one or more applications containing visual data;
in response to receiving the notification, examining the visual data contained in the one or more applications;
determining if at least a portion of the visual data is included in the privacy criteria;
in response to determining that at least a portion of the visual data is included in the privacy criteria, setting the display to the second physical state; and
in response to determining that none of the visual data is included in the privacy criteria, setting the display to the first physical state.

15. The method of claim 14, wherein the first physical state includes the display displaying at a high-brightness level.

16. The method of claim 14, wherein the second physical state includes the display displaying at a low-brightness level.

17. The method of claim 14, wherein the first physical state includes the display displaying at an optimal level of contrast.

18. The method of claim 14, wherein the second physical state includes the display displaying at a sub-optimal level of contrast.

19. The method of claim 14, wherein the steps of setting the display to the first and the second physical states are performed with no user intervention.

20. The method of claim 14, wherein the steps of setting the display to the first and the second physical states are performed by the OS.

21. The method of claim 14, wherein the steps of setting the display to the first and the second physical states are performed by a browser-enabled application.

22. A system for associating privacy settings with content displayed on a display of an electronic device, the privacy settings include changing physical attributes of the display, the system comprising:
means for defining criteria for invoking the privacy settings, the criteria includes selecting attributes of content displayable by the electronic device;
means for retrieving generalized content displayed by one or more applications on the electronic device;
means for comparing the generalized content with the criteria;
means for determining the criteria to be included in the generalized content;
means for invoking the privacy settings in response to the determination; and
means for changing the physical attributes of the display.

23. The system of claim 22, wherein the means for changing the physical attribute of the display includes means for transmitting an instruction from an operating system (“OS”) running on the electronic device to the display.

24. The system of claim 23, wherein the instruction causes the display to alter its brightness level.

25. The system of claim 24, wherein in response to determining the criteria to be included in the generalized content, altering the brightness level to a less-than-optimal state.

26. The system of claim 24, wherein in response to determining the criteria to not be included in the generalized content, altering the brightness level to an optimal state.

27. The system of claim 22, wherein the content displayed by one or more applications on the electronic device includes an electronic communication from a remote user.

28. The system, of claim 27, wherein the electronic communication is an instant message (“IM”);

29. The system, of claim 27, wherein the electronic communication is a web-based message from a social network.
